(19) United States
(12) Patent Application Publication
(10) Pub. No.: US 2023/0220707 A1
(43) Pub. Date: Jul. 13, 2023

(54) DOOR LATCH ASSEMBLY

(71) Applicant: Ford Global Technologies, LLC, Dearborn, MI (US)

(72) Inventors: Alvin Chu, Hayward, CA (US); Brian Ka-Bo Ngo, San Francisco, CA (US); Michael M. Azzouz, Farmington, MI (US); Siddharthan Selvasekar, Livermore, CA (US)

(73) Assignee: Ford Global Technologies, LLC, Dearborn, MI (US)

(21) Appl. No.: 17/718,656

(22) Filed: Apr. 12, 2022

Related U.S. Application Data
(63) Continuation-in-part of application No. 17/572,013, filed on Jan. 10, 2022.

(51) Int. Cl. E05C 9/04; B60R 7/04

(52) U.S. Cl. CPC E05C 9/04; B60R 7/04

(57) ABSTRACT

A latch feature for a door includes an input body operable to pivot between first and second positions relative to the door and having an input body slide feature. The latch feature further includes an output body coupled to the input body by a pivot member and having an output body slide feature that is operable to slide along the input body slide feature. The contact between the input body slide feature and the output body slide feature causes the output body to move from an outboard position to an inboard position as the input body pivots from the first position to the second position.

### CROSS-REFERENCE TO RELATED APPLICATION

This application is a continuation-in-part of and claims priority under 35 U.S.C. § 120 to commonly owned, co-pending, related U.S. patent application Ser. No. 17/572,013, filed Jan. 10, 2022, entitled DOOR LATCH ASSEMBLY, the entire disclosure of which is incorporated herein by reference.

### FIELD OF THE DISCLOSURE

The present disclosure generally relates to a door latch assembly. More specifically, the present disclosure relates to a latch assembly for a door of a storage compartment within a vehicle.

### BACKGROUND OF THE DISCLOSURE

A vehicle typically includes at least one storage compartment within the vehicle that is accessible through a door coupled to the storage compartment. Storage compartment doors often include a latch assembly with a multitude of parts that cooperate together to latch the door in a closed position. A door latch assembly with fewer components may be desired.

### SUMMARY OF THE DISCLOSURE

According to a first aspect of the present disclosure, a door latch assembly includes a door operable between open and closed positions, a housing coupled to the door, and a latch feature coupled to the housing and operable, in the closed position of the door, between an engaged condition and a disengaged condition. In the engaged condition, the latch feature is engaged with a receiver to retain the door in the closed position. The latch feature includes an input body having an input body slide feature and being operably coupled to at least one of the housing and the door and pivotable about an input body pivot axis between first and second positions. Movement of the input body between the first and second positions is constrained to pivotal movement by at least one of the housing and the door. The latch feature also includes an output body coupled to the input body by at least one pivot member and having an output body slide feature that is operable to slide along the input body slide feature. The contact between the input body slide feature and the output body slide feature prompts movement of the output body from an outboard position to an inboard position as the input body pivots from the first position to the second position. The output body slide feature slides along the input body slide feature as the output body moves from the outboard position to the inboard position. The at least one pivot member is configured to pivot to allow the output body to move from the outboard position to the inboard position. Further, movement of the output body from the outboard position to the inboard position causes the latch feature to enter the disengaged condition in the closed position of the door.

Embodiments of the first aspect of the present disclosure can include any one or a combination of the following features:
the input body slide feature extends from a proximal end to a distal end that is positioned outboard of the proximal end, and the output body slide feature slides along the input body slide feature toward the proximal end of the input body slide feature as the output body moves from the outboard position to the inboard position;
the input body includes an engagement surface configured to be pushed by a user to move the input body from the first position to the second position;
the proximal end of the input body slide feature is positioned proximate to the engagement surface, and at least a portion of the input body slide feature slopes outboard and away from the engagement surface toward the distal end, such that the distal end is outboard of the proximal end and further than the proximal end from the engagement surface;
the output body slide feature includes a post that extends outward from the output body generally toward the input body pivot axis;
movement of the output body from the outboard position to the inboard position is constrained to substantially linear movement by the housing;
the direction of the linear movement of the output body from the outboard position to the inboard position is substantially parallel to the input body pivot axis;
the input body is integrally coupled to the at least one pivot member and the at least one pivot member is integrally coupled to the output body;
at least a portion of the output body is angled upward and inboard in the closed position of the door and the outboard position of the output body; and
at least a portion of the output body is angled upward and inboard at an angle of about 3 degrees relative to a horizontal plane.

According to a second aspect of the present disclosure, a latch feature includes an input body having a first input body slide feature and a second input body slide feature and being operable to pivot relative to at least one of a housing and a door about an input body pivot axis between first and second positions. The latch feature also includes a first output body coupled to the input body by at least one first pivot member and having a first output body slide feature that is operable to slide along the first input body slide feature. Contact between the first input body slide feature and the first output body slide feature prompts movement of the first output body from a first outboard position to a first inboard position as the input body pivots from the first position to the second position. The first output body slide feature slides along the first input body slide feature as the first output body moves from the first outboard position to the first inboard position. The at least one first pivot member is configured to pivot to allow the first output body to move from the first outboard position to the first inboard position as the input body pivots from the first position to the second position. The latch feature further includes a second output body coupled to the input body by at least one second pivot member and having a second output body slide feature that is operable to slide along the second input body slide feature. Contact between the second input body slide feature and the second output body slide feature prompts movement of the second output body from a second outboard position to a second inboard position as the input body pivots from the first position to the second position. The second output body slide feature slides along the second input body slide feature as the second output body moves from the second outboard position to the second inboard position. The at least one second pivot member is configured to pivot to allow the second output body to move from the second outboard position to the second inboard position as the input body pivots from the first position to the second position.

Embodiments of the second aspect of the present disclosure can include any one or a combination of the following features:
the input body pivot axis is substantially parallel to the direction the first output body moves from the first outboard position to the first inboard position;
the first and second output body slide features move nearer to each other as the first and second output bodies move from the first and second outboard positions to the first and second inboard positions, respectively;
the first input body slide feature extends from a proximal end to a distal end that is positioned outboard of the proximal end, and the first output body slide feature slides along the first input body slide feature toward the proximal end of the first input body slide feature as the first output body moves from the first outboard position to the first inboard position;
the input body includes an engagement surface configured to be pushed by a user to move the input body from the first position to the second position;
the proximal end of the first input body slide feature is positioned proximate to the engagement surface, and at least a portion of the first input body slide feature slopes outboard and away from the engagement surface toward the distal end, such that the distal end is outboard of the proximal end and further than the proximal end from the engagement surface;
the first output body slide feature includes a post that extends outward from the first output body generally toward the input body pivot axis; and
the at least one first pivot member is configured to bias the input body toward the first position and the first output body toward the first outboard position.

According to a third aspect of the present disclosure, a latch feature for a door includes an input body operable to pivot between first and second positions relative to the door and having an input body slide feature. The latch feature further includes an output body coupled to the input body by a pivot member and having an output body slide feature that is operable to slide along the input body slide feature. The contact between the input body slide feature and the output body slide feature causes the output body to move from an outboard position to an inboard position as the input body pivots from the first position to the second position.

Embodiments of a third aspect of the present disclosure can include the following feature:
the input body is integrally coupled to the pivot member and the pivot member is integrally coupled to the output body.

These and other aspects, objects, and features of the present disclosure will be understood and appreciated by those skilled in the art upon studying the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1A is a perspective view of a vehicle interior of a vehicle, illustrating a door of a console box in a closed position, according to one embodiment;

FIG. 1B is a perspective view of the vehicle interior, illustrating the door of the console box in an open position, according to one embodiment;

FIG. 2 is a plan view of a door latch assembly, illustrating a latch feature and a housing coupled to the door, according to one embodiment;

FIG. 3 is a top perspective view of the latch feature and the housing, according to one embodiment;

FIG. 4A is a top perspective view of the latch feature, illustrating an input body of the latch feature in a first position, first and second output bodies of the latch feature in outboard positions, and a connecting body in a first connecting body position, according to one embodiment;

FIG. 4B is a top perspective view of the latch feature, illustrating the input body of the latch feature in a second position, the first and second output bodies of the latch feature in inboard positions, and the connecting body in a second connecting body position, according to one embodiment;

FIG. 5A is a top perspective view of the latch feature, illustrating the input body of the latch feature in the first position, first and second output bodies of the latch feature in outboard positions, and first and second output body slide features in contact with corresponding first and second input body slide features, according to one embodiment;

FIG. 5B is a top perspective view of the latch feature, illustrating the input body of the latch feature in the second position, the first and second output bodies of the latch feature in inboard positions, and the first and second output body slide features in contact with the corresponding first and second input body slide features, according to one embodiment; and

FIG. 6 is a front elevational view of the latch feature, illustrating portions of the first and second output bodies extending at an angle relative to the input body pivot axis, according to one embodiment.

### DETAILED DESCRIPTION OF THE PREFERRED EMBODIMENTS

Additional features and advantages of the invention will be set forth in the detailed description which follows and will be apparent to those skilled in the art from the description, or recognized by practicing the invention as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as “first” and “second,” “top” and “bottom,” and the like, are used solely to distinguish one entity or action from another entity or action, without necessarily requiring or implying any actual such relationship or order between such entities or actions.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and/or any additional intermediate members. Such joining may include members being integrally formed as a single unitary body with one another (i.e., integrally coupled) or may refer to joining of two components. Such joining may be permanent in nature, or may be removable or releasable in nature, unless otherwise stated.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

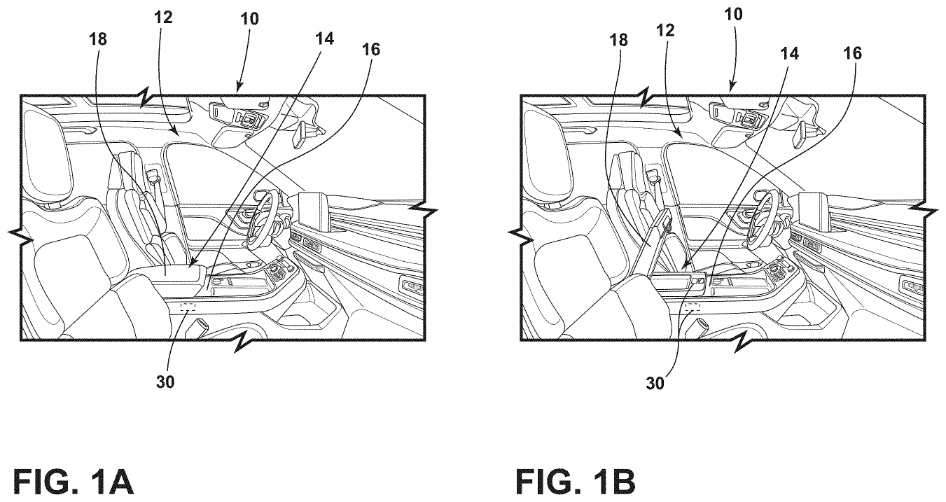

Referring now to FIGS. 1A-4B, a door latch assembly 26 may include a door 18 that is operable between open and closed positions. A housing 22 may be coupled to the door 18. A latch feature 24 may be coupled to the housing 22 and may be operable, in the closed position of the door, between an engaged condition, wherein the latch feature 24 is engaged with a receiver 30 to retain the door 18 in the closed position, and a disengaged condition. The latch feature 24 includes an input body 32 that is operably coupled to the housing 22 and pivotable about an input body pivot axis 42 between first and second positions relative to the housing 22. Movement of the input body 32 between the first and second positions is constrained to pivotal movement by the housing 22. The latch feature 24 further includes an output body 46 that is coupled to the input body 32 by at least one pivot member 48. The at least one pivot member 48 is configured to pivot to allow the output body 46 to move toward the input body 32 from an outboard position to an inboard position as the input body 32 pivots from the first position to the second position. Movement of the output body 46 from the outboard position to the inboard position is constrained to substantially linear movement by the housing 22 and causes the latch feature 24 to enter the disengaged condition in the closed position of the door 18.

Referring now to FIGS. 1A and 1B, a vehicle 10 includes a vehicle interior 12. At least one storage compartment 14 is disposed within the vehicle interior 12. In various embodiments, the vehicle interior 12 may include a plurality of storage compartments 14. For example, the vehicle interior 12 may include an overhead console that defines a storage compartment 14, a glovebox, and a console storage box. In the embodiment illustrated in FIGS. 1A and 1B, the vehicle interior 12 includes the storage compartment 14 in the form of a center console 16. As illustrated, the door 18 is coupled to the center console 16 and operable between a closed position, as illustrated in FIG. 1A, and an open position, as illustrated in FIG. 1B. The door 18 may move between the closed position and the open position by pivoting relative to the storage compartment 14.

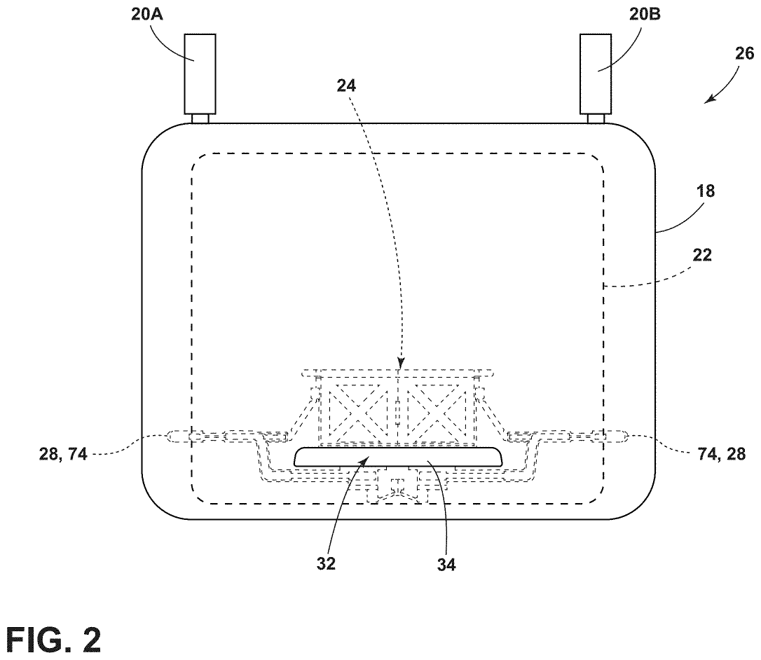

Referring now to FIG. 2, the door 18 of the storage compartment 14 is embodied as the center console 16 illustrated in FIGS. 1A and 1B. In the depicted embodiment, first and second connectors 20A, 20B are coupled to a first end of the door 18. The first and second connectors 20A, 20B are configured to couple the door 18 to the storage compartment 14 and allow the door 18 to pivot between the open and closed positions relative to the storage compartment 14. As illustrated in FIG. 2, a housing 22 and a latch feature 24 may be coupled to the door 18 at a second end of the door 18 opposite the first end. As discussed further herein, the door 18, the housing 22, and the latch feature 24 may cooperate to form a door latch assembly 26.

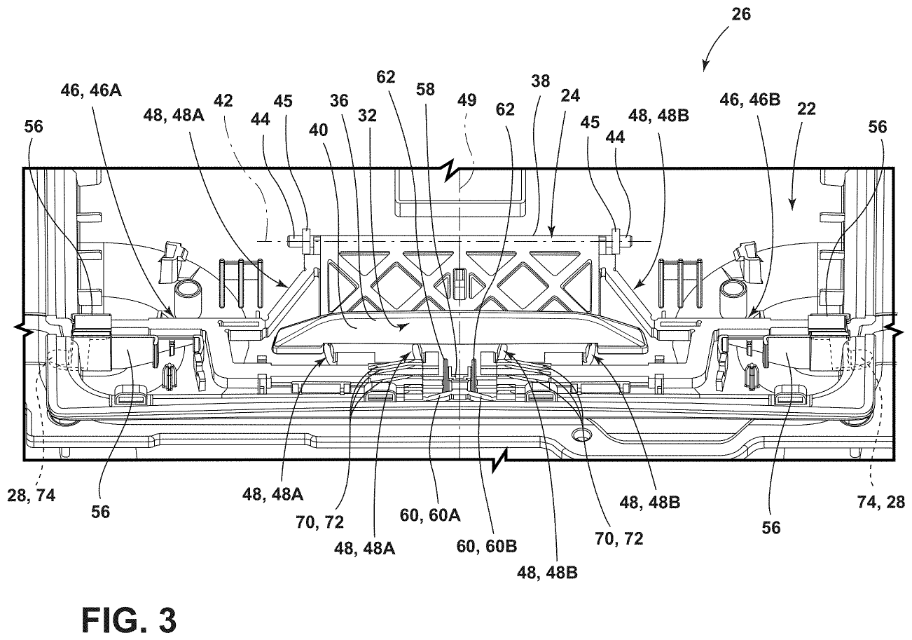

Referring now to FIGS. 2 and 3, the door latch assembly 26 includes the housing 22. The housing 22 may be coupled to the door 18. In some embodiments, the housing 22 may be integrally coupled with the door 18. In other words, the housing 22 and the door 18 may be a single unitary body, such that the housing 22 is a portion of the door 18. In some embodiments, the housing 22 may include a portion of the door 18 in combination with a separate component that is coupled to the door 18.

In various embodiments, the door latch assembly 26 includes the latch feature 24. The latch feature 24 may be coupled to the housing 22 and operable, if the door 18 is in the closed position, between an engaged condition and a disengaged condition. In the engaged condition, the latch feature 24 may be configured to retain the door 18 in the closed position. In the disengaged condition, the latch feature 24 may be configured to not prevent movement of the door 18 from the closed position to the open position. In other words, when the latch feature 24 is in the disengaged condition, the door 18 may be operable to move between the open and closed positions. As described further herein, the latch feature 24 may be configured to retain the door 18 in the closed position while the latch feature 24 is in the engaged condition in a variety of ways. For example, the latch feature 24 may include at least one engagement feature 28 that is configured to be engaged with a receiver 30 coupled to the storage compartment 14 when the door 18 is in the closed position, and the latch feature 24 is in the engaged condition. In various implementations, the engagement feature 28 may be one or more of a variety of features configured to engage the receiver 30 coupled to the storage compartment 14 (e.g., latch bolt, latch pawl, etc.). Further, in various embodiments, the receiver 30 coupled to the storage compartment 14 may be one or more of a variety of features configured to receive the engagement feature 28 when the engagement feature 28 is in the engaged condition (e.g., keeper, striker, aperture, slot, etc.).

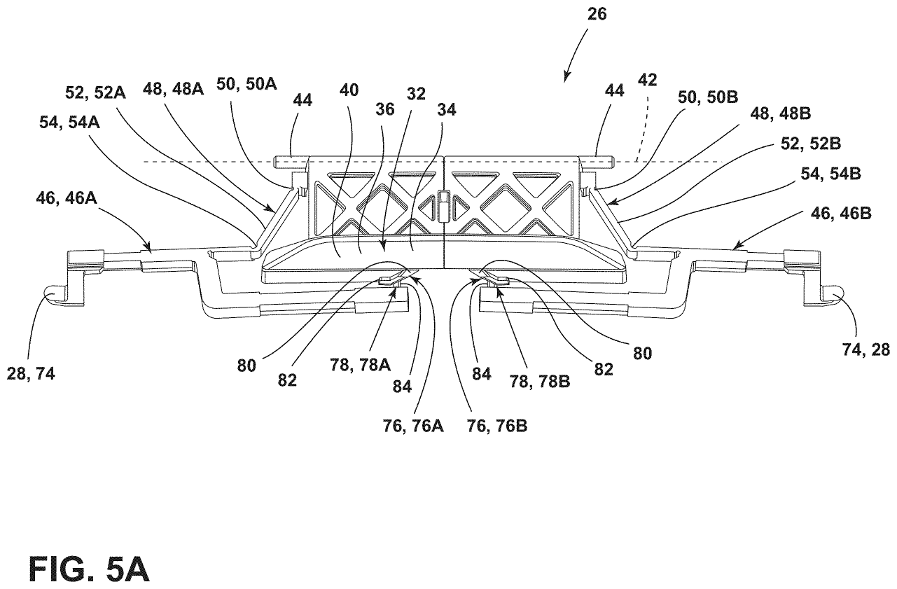

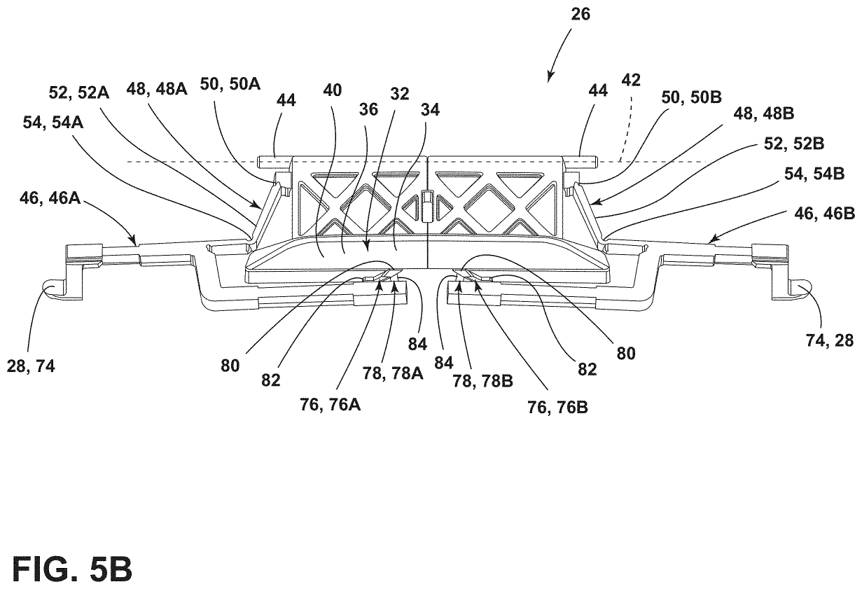

Referring now to FIGS. 2-5, the latch feature 24 may include an input body 32. The input body 32 may be operably coupled to the housing 22 and movable between first and second positions relative to the housing 22. In various embodiments, the input body 32 may be configured to be moved by a user from the first position to the second position. In the embodiment illustrated in FIGS. 2-4B, the input body 32 includes an engagement surface 34 configured to be pushed by a user to move the input body 32 from the first position to the second position. The engagement surface 34 may be disposed at a first end 36 of the input body 32, and the input body 32 may extend from the engagement surface 34 at the first end 36 of the input body 32 to a second end 38 of the input body 32 distal from the first end 36. In some embodiments, the engagement surface 34 of the input body 32 may extend outward from the portion of the input body 32 between the engagement surface 34 and the second end 38 to form a tang 40, as illustrated in FIGS. 3 and 5. In some implementations, the engagement surface 34 of the input body 32 may serve as a button that is configured to be pushed by a user, as illustrated in FIG. 2. It is contemplated that, in some embodiments, the input body 32 may be moved between the first and second positions relative to the housing 22 in a variety of ways. For example, in some embodiments, the input body 32 may be pulled from the first position to the second position.

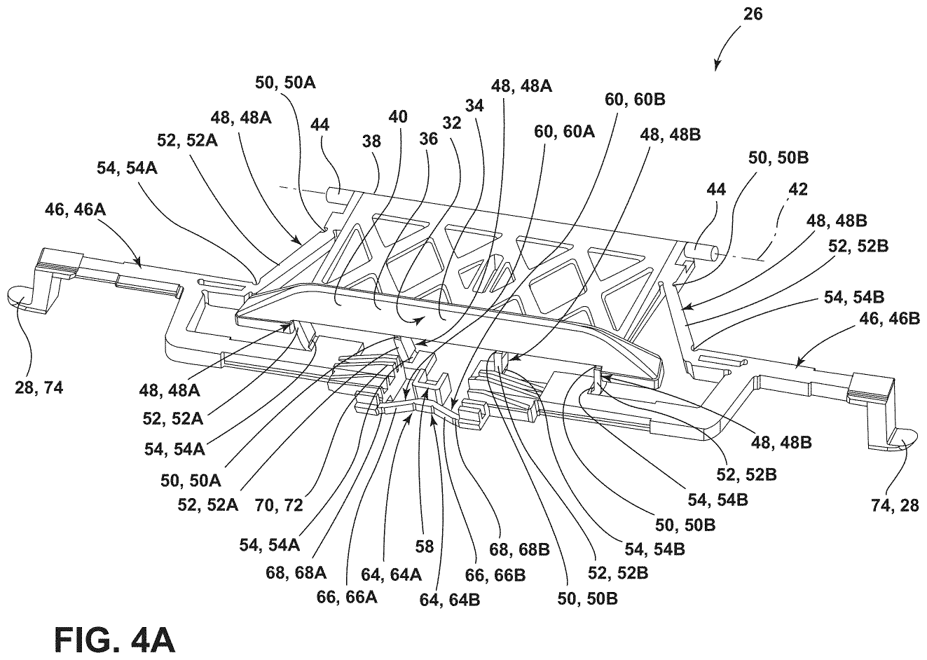

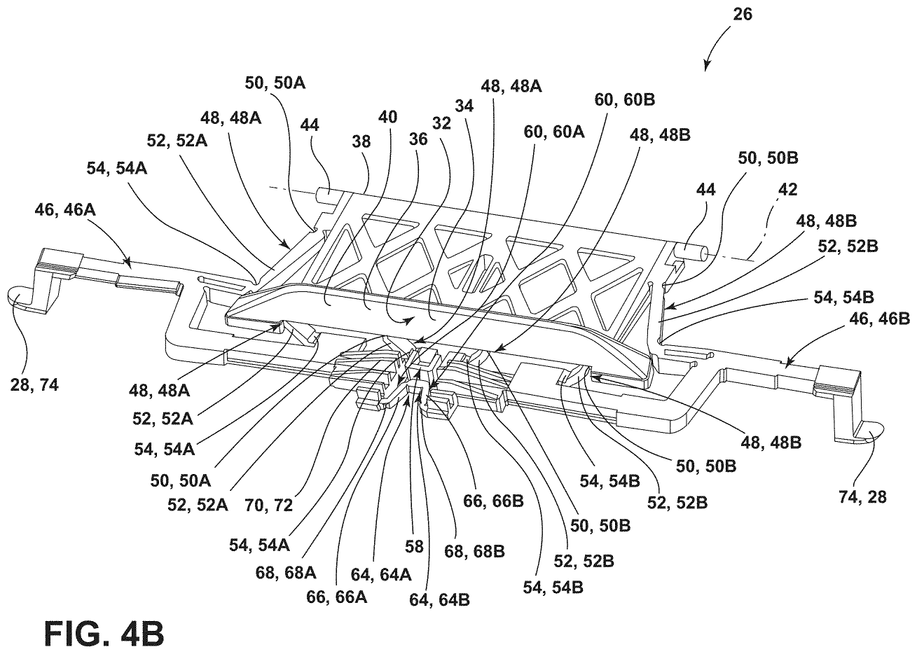

In various embodiments, movement of the input body 32 between the first and second positions relative to the housing 22 may be constrained to pivotal movement by at least one of the housing 22 and the door 18. In some implementations, the input body 32 may be pivotably coupled to the housing 22 and/or the door 18 proximate to the second end 38 of the input body 32 and operable to pivot between the first and second positions about an input body pivot axis 42. For example, in the embodiment illustrated in FIGS. 3-4B, the input body 32 includes a pair of pivot rods 44 that are pivotably engaged with anchoring features 45 of the housing 22. The input body 32 is configured to be pivoted between the first and second positions about the input body pivot axis 42 via rotational movement of pivot rods 44 relative to the anchoring features 45. It is contemplated that the housing 22 may constrain movement of the input body 32 to pivotal movement in a variety of ways.

Referring now to FIGS. 2-4B, in various embodiments, the latch feature 24 may include at least one output body 46 coupled to the input body 32 by at least one pivot member 48 that is configured to allow the output body 46 to move from an outboard position to an inboard position as the input body 32 moves from the first position to the second position. In some embodiments, the latch feature 24 may include a plurality of output bodies 46 coupled to the input body 32 by a plurality of pivot members 48. For example, in some embodiments, the latch feature 24 includes a first output body 46A coupled to the input body 32 by at least one first pivot member 48A and a second output body 46B coupled to the input body 32 by at least one second pivot member 48B. As illustrated in FIGS. 4A and 4B, the first and second output bodies 46A, 46B are positioned on opposite sides of the input body 32, such that the first and second output bodies 46A, 46B move toward each other when moving from the outboard positions to the inboard positions, respectively, and move away from each other when moving from the inboard positions to the outboard positions, respectively. In some embodiments, a plurality of first pivot members 48A may couple the first output body 46A to the input body 32 and a plurality of second pivot members 48B may couple the second output body 46B to the input body 32. For example, as illustrated in FIGS. 3-4B, three first pivot members 48A couple the first output body 46A to the input body 32 and three second pivot members 48B couple the second output body 46B to the input body 32.

Referring now to FIGS. 3-4B, in some embodiments, the at least one pivot member 48 may be coupled to the input body 32 proximate to the second end 38 of the input body 32 that is distal from the first end 36 where the engagement surface 34 is positioned. In some embodiments, the at least one pivot member 48 may be coupled to the input body 32 proximate to the first end 36 of the input body 32 that is distal from the input body pivot axis 42. In some embodiments, wherein the latch feature 24 includes a plurality of pivot members 48 that each extend between the input body 32 and the output body 46, at least one of the plurality of pivot members 48 may be coupled to the input body 32 proximate to the second end 38, and at least one of the plurality of pivot members 48 may be coupled to the input body 32 proximate to the first end 36. Further, in some embodiments, at least one of the plurality of pivot members 48 may extend inboard from the input body 32 to the output body 46, and at least one of the plurality of pivot members 48 may extend outboard from the input body 32 to the output body 46.

In the exemplary embodiment illustrated in FIGS. 3-4B, the latch feature 24 includes three first pivot members 48A that extend between the input body 32 and the first output body 46A. As illustrated, one of the three first pivot members 48A is coupled to the input body 32 proximate to the second end 38 of the input body 32 and extends outboard to the first output body 46A, and two of the three first pivot members 48A are coupled to the input body 32 proximate to the first end 36 and extend inboard to the first output body 46A. In the illustrated embodiment, the latch feature 24 also includes three second pivot members 48B that extend between the input body 32 and the second output body 46B. As illustrated, one of the three second pivot members 48B is coupled to the input body 32 proximate to the second end 38 of the input body 32 and extends outboard to the second output body 46B, and two of the three second pivot members 48B are coupled to the input body 32 proximate to the first end 36 and extend inboard to the second output body 46B.

In various implementations, “inboard” and “outboard” are defined relative to a virtual center plane 49 of the latch feature 24. The virtual center plane 49 extends perpendicularly to the input body pivot axis 42 (i.e., the input body pivot axis 42 extends in a direction normal to the virtual center plane 49), and, as illustrated in FIG. 3, the virtual center plane 49 extends through a midpoint of the input body 32. Accordingly, in various embodiments, an outboard position is further than a corresponding inboard position from the virtual center plane 49. Further, the at least one pivot member 48 extends outboard from the input body 32 to the first output body 46A, in that the at least one pivot member 48 extends away from the virtual center plane 49 from the input body 32 to the first output body 46A. Further, the at least one pivot member 48 extends inboard from the input body 32 to the first output body 46A, in that the at least one pivot member 48 extends toward the virtual center plane 49 from the input body 32 to the first output body 46A. It is to be understood that movement in an inboard direction (i.e., inboard movement) is movement toward the virtual center plane 49, and that movement in an outboard direction (i.e., outboard movement) is movement away from the virtual center plane 49, in various implementations. Inboard and outboard movements are not limited to movement in a direction that is perpendicular to the virtual center plane 49.

Referring still to FIGS. 3-4B, in some embodiments, the at least one pivot member 48 may be integrally coupled to the input body 32 and/or the output body 46. In other words, the input body 32, the at least one pivot member 48, and/or the at least one output body 46 may be integrally coupled as a single unitary body. In various embodiments, the at least one pivot member 48 may include a proximal living hinge 50, a leaf 52, and a distal living hinge 54. The proximal living hinge 50 may be coupled to the input body 32. The leaf 52 may be coupled to the proximal living hinge 50 and may extend outward to the distal living hinge 54. The distal living hinge 54 may be coupled to the at least one output body 46. The proximal and distal living hinges 50, 54 of the at least one pivot member 48 may have a thickness that is less than a thickness of the leaf 52 extending between the proximal and distal living hinges 50, 54. For example, as illustrated in FIG. 3, the proximal living hinge 50 of the first pivot member 48A that is coupled to the input body 32 proximate to the second end 38 defines two generally rounded cutouts that face toward and away from the input body 32, respectively. Further, the distal living hinge 54 of the first pivot member 48A defines a generally rounded cutout.

The proximal and distal living hinges 50, 54 are configured to elastically deform to allow the leaf 52 to pivot relative to both the input body 32 and the at least one output body 46. For example, as illustrated in FIGS. 4A and 4B, as the input body 32 moves from the first position (FIG. 4A) to the second position (FIG. 4B), the first and second output bodies 46A, 46B are moved from the outboard positions to the inboard positions due to the first and second output bodies 46A, 46B being coupled to the input body 32 by the first and second pivot members 48A, 48B, respectively. To accommodate the housing 22 constraining both the movement of the input body 32 to pivotal movement and the movement of the first and second output bodies 46A, 46B to linear movement, as described further herein, the first and second pivot members 48A, 48B pivot relative to the input body 32 via deformation of the proximal living hinges 50 and pivot relative to the first and second output bodies 46A, 46B via deformation of the distal living hinges 54.

As illustrated in FIGS. 4A and 4B, each of the first pivot members 48A includes a first proximal living hinge 50A, a first leaf 52A, and a first distal living hinge 54A. Further, each of the second pivot members 48B includes a second proximal living hinge 50B, a second leaf 52B, and a second distal living hinge 54B. As such, to accommodate the housing 22 constraining the movement of the input body 32 to pivotal movement and the movement of the first output body 46A to linear movement, as described further herein, each of the first pivot members 48A pivots relative to the input body 32 via deformation of the corresponding first proximal living hinge 50A and pivots relative to the first output body 46A via deformation of the corresponding first distal living hinge 54A. Further, to accommodate the housing 22 constraining the movement of the input body 32 to pivotal movement and the movement of the second output body 46B to linear movement, each of the second pivot members 48B pivots relative to the input body 32 via deformation of the corresponding second proximal living hinge 50B and pivots relative to the second output body 46B via deformation of the corresponding second distal living hinge 54B.

Referring now to FIG. 3, in various embodiments, movement of the at least one output body 46 from the outboard position to the inboard position is constrained to substantially linear movement by the housing 22. As illustrated in FIGS. 4A and 4B, the housing 22 includes at least one guide feature 56 configured to contact the output body 46, such that movement of the output body 46 from the outboard position to the inboard position is constrained by the at least one guide feature 56 to linear movement. In the depicted embodiment, the at least one guide feature 56 includes walls. It is contemplated that, in various embodiments, the at least one guide feature 56 may include at least one of a variety of features configured to constrain movement of the at least one output body 46 between the inboard and outboard positions to linear movement, such as a linear track along which the at least one output body 46 is configured to slide. In some embodiments, the input body pivot axis 42 about which the input body 32 pivots from the first position to the second position may be substantially parallel to the direction of the linear movement of the at least one output body 46 from the outboard position to the inboard position.

Referring now to FIGS. 3-4B, in some embodiments, the latch feature 24 may include a connecting body 58. The connecting body 58 may be coupled to at least one output body 46 by at least one connecting member 60. In some embodiments, the connecting body 58 may be coupled to the first output body 46A by a first connecting member 60A and may be connected to the second output body 46B by a second connecting member 60B. The connecting body 58 may be operable to move between a first connecting body position, as illustrated in FIG. 4A, and a second connecting body position, as illustrated in FIG. 4B. In various embodiments, movement of at least one output body 46 between the outboard and inboard positions may cause movement of the connecting body 58 between the first and second connecting body positions, respectively. In the embodiment illustrated in FIGS. 4A and 4B, pivoting movement of the first connecting member 60A relative to the first output body 46A and the connecting body 58 and pivoting movement of the second connecting member 60B relative to the second output body 46B and the connecting body 58 allows for movement of the connecting body 58 from the first connecting body position to the second connecting body position simultaneously with movement of the first and second output bodies 46A, 46B from the outboard positions to the inboard positions, respectively.

In various embodiments, force exerted by a user on the input body 32 drives movement of the input body 32 from the first position to the second position, movement of the input body 32 from the first position to the second position drives movement of the first and second output bodies 46A, 46B from the respective outboard positions to the respective inboard positions, and movement of the first and second output bodies 46A, 46B from the respective outboard positions to the respective inboard positions drives movement of the connecting body 58 from the first connecting body position to the second connecting body position.

Referring now to FIG. 3, in some embodiments, the movement of the connecting body 58 may be constrained by the housing 22 to substantially linear movement. In the embodiment illustrated in FIG. 3, the housing 22 includes bracing features 62 that extend along opposite sides of the connecting body 58. The bracing features 62 are configured to constrain movement of the connecting body 58 to the linear movement between the bracing features 62. In various embodiments, the connecting body 58 may move substantially perpendicularly to the input body pivot axis 42 between the first and second connecting body positions. In some embodiments, the connecting body 58 may move toward the input body pivot axis 42 from the first connecting body position to the second connecting body position. In some embodiments, movement of the connecting body 58 between the first and second connecting body positions may be substantially perpendicular to movement of the at least one output body 46 between the inboard and outboard positions.

Referring still to FIGS. 3-4B, in some embodiments, the at least one connecting member 60 may be integrally coupled to the connecting body 58 and/or the output body 46. In other words, the connecting body 58, the at least one connecting member 60, and/or the at least one output body 46 may be integrally coupled as a single unitary body. In various embodiments, the at least one connecting member 60 may include a proximal living hinge 64, a leaf 66, and a distal living hinge 68. The proximal living hinge 64 may be coupled to the connecting body 58. The leaf 66 may be coupled to the proximal living hinge 64 and may extend outward to the distal living hinge 68. The distal living hinge 68 may be coupled to the output body 46. The proximal and distal living hinges 64, 68 of the at least one connecting member 60 may have a thickness that is less than a thickness of the leaf 66 extending between the proximal and distal living hinges 64, 68.

The proximal and distal living hinges 64, 68 of the connecting member 60 are configured to elastically deform to allow the leaf 66 to pivot relative to both the connecting body 58 and the at least one output body 46. For example, as illustrated in FIGS. 4A and 4B, as the first and second output bodies 46A, 46B are moved from the outboard positions (FIG. 4A) to the inboard positions (FIG. 4B), the connecting body 58 is moved from the first connecting body position to the second connecting body position due to the connecting body 58 being coupled to the first and second output bodies 46A, 46B by the first and second connecting members 60A, 60B, respectively. To accommodate the housing 22 constraining both the movement of the connecting body 58 to substantially linear movement and the movement of the first and second output bodies 46A, 46B to substantially linear movement, the first and second connecting members 60A, 60B pivot relative to the connecting body 58 via deformation of the proximal living hinges 64 and pivot relative to the first and second output bodies 46A, 46B via deformation of the distal living hinges 68.

As illustrated in FIGS. 4A and 4B, the first connecting member 60A includes a first proximal living hinge 64A, a first leaf 66A, and a first distal living hinge 68A. Further, the second connecting member 60B includes a second proximal living hinge 64B, a second leaf 66B, and a second distal living hinge 68B. As such, to accommodate the housing 22 constraining the movement of the connecting body 58 to substantially linear movement and the movement of the first output body 46A to substantially linear movement, the first connecting member 60A pivots relative to the connecting body 58 via deformation of the corresponding first proximal living hinge 64A and pivots relative to the first output body 46A via deformation of the corresponding first distal living hinge 68A. Further, to accommodate the housing 22 constraining the movement of the connecting body 58 to substantially linear movement and the movement of the second output body 46B to substantially linear movement, the second connecting member 60B pivots relative to the connecting body 58 via deformation of the corresponding second proximal living hinge 64B and pivots relative to the second output body 46B via deformation of the corresponding second distal living hinge 68B.

In various embodiments, the at least one connecting member 60 may be configured to bias the connecting body 58 toward the first connecting body position and the output body 46 toward the outboard position. For example, the proximal and distal living hinges 64, 68 may be elastically deformed when the connecting body 58 is in the second connecting body position and the at least one output body 46 is in the inboard position, as illustrated in FIG. 4B. Upon removal of the force holding the connecting body 58 in the second connecting body position and/or the at least one output body 46 in the inboard position, the proximal and distal living hinges 64, 68 may be configured to resiliently rebound back toward an at rest position and move the connecting body 58 back toward the first connecting body position and the at least one output body 46 back toward the outboard position, as illustrated in FIG. 4A.

Referring now to FIGS. 3-4B, in various embodiments, the at least one output body 46 may include a vertical alignment feature 70. The vertical alignment feature 70 may extend upward from the at least one output body 46, such that the vertical alignment feature 70 is the upward-most portion of the output body 46. The vertical alignment feature 70 may be configured to contact another portion of the door latch assembly 26, such as the housing 22 and/or the door 18, to prevent the at least one output body 46 from deviating vertically from the travel path on which the at least one output body 46 travels between the inboard and outboard positions. In the embodiment illustrated in FIGS. 3-4B, the first and second output bodies 46A, 46B include vertical alignment features 70 in the form of ribs 72 that are coupled to the inboard-most portions of the first and second output bodies 46A, 46B. A variety of types of vertical alignment features 70 are contemplated.

In various embodiments, the at least one output body 46 may include the engagement feature 28. For example, as illustrated in FIGS. 4A and 4B, the first and second output bodies 46A, 46B include pawls 74. In the illustrated embodiments, the pawls 74 extend outward from the first and second output bodies 46A, 46B, and form the outboard-most portions of the latch feature 24. The engagement feature 28 of the at least one output body 46 of the latch feature 24 is configured for selective engagement with the receiver 30 of the storage compartment 14 when the door 18 is in the closed position, as described herein.

In various embodiments, in the closed position of the door, the engagement feature 28 of the at least one output body 46 is configured to be engaged with the receiver 30 of the storage compartment 14 when the at least one output body 46 is in the outboard position. Movement of the input body 32 from the first position to the second position causes the at least one output body 46 to move from the outboard position to the inboard position, which may disengage the engagement feature 28 from the receiver 30 of the storage compartment 14, such that the door 18 may be moved from the closed position to the open position. In some embodiments, wherein the engagement feature 28 includes the pawl 74, movement of the door 18 from the open position to the closed position may cause the pawl 74 to contact the receiver 30 (e.g., striker) and move from the outboard position to the inboard position due to the contact between the pawl 74 and the receiver 30. The output body 46 may be biased toward the outboard position, such that after moving inboard due to the contact with the receiver 30, the at least one output body 46 may move back to the outboard position, such that the pawl 74 is engaged with the receiver 30 to latch the door 18 in the closed position. In various embodiments, the latch feature 24 may be a single unitary body.

In operation of an exemplary embodiment of the door latch assembly 26, initially, the door 18 of the center console 16 within the vehicle interior 12 is in the closed position and the latch feature 24 coupled to the door 18 is in a latched position relative to the center console 16, such that the latch feature 24 prevents the door 18 from being moved from the closed position to the open position. In this configuration, the input body 32 of the latch feature 24 is in the first position, the first and second output bodies 46A, 46B of the latch feature 24 are in the outboard positions such that the pawls 74 coupled to the first and second output bodies 46A, 46B are engaged with corresponding receivers 30 coupled to the storage compartment 14, and the connecting body 58 is in the first connecting body position.

Next, the user pushes the engagement surface 34 coupled to the input body 32 of the latch feature 24, which causes the input body 32 to pivot from the first position to the second position about the input body pivot axis 42. Movement of the input body 32 from the first position to the second position causes the first and second output bodies 46A, 46B to move toward the input body 32 from outboard positions to inboard positions along substantially linear paths that are substantially parallel to the input body pivot axis 42, due to the constraining forces applied to the first and second output bodies 46A, 46B by the guide features 56 of the housing 22. Movement of the first and second output bodies 46A, 46B from the outboard positions to the inboard positions causes the connecting body 58 to move substantially linearly from the first connecting body position to the second connecting body position. Movement of the first and second output bodies 46A, 46B to the inboard positions disengages the pawls 74 coupled to the first and second output bodies 46A, 46B from the corresponding receivers 30 of the storage compartment 14, such that the door 18 may be pivoted from the closed position to the open position.

The user stops pushing on the engagement surface 34 of the input body 32 as the door 18 is swung from the closed position to the open position. As the user releases the engagement surface 34, the first and second output bodies 46A, 46B move from the inboard positions to the outboard positions, the connecting member 60 moves from the second connecting member position to the first connecting member position, and the input body 32 moves from the second position back to the first position.

Next, the user moves the door 18 from the open position back to the closed position. As the door 18 enters the closed position, the pawls 74 coupled to the first and second output bodies 46A, 46B contact portions of the receiver 30 of the storage compartment 14 in such a way that the first and second output bodies 46A, 46B are moved toward the inboard positions as the door 18 moves toward the closed position. As the door 18 enters the closed position, the pawls 74 of the first and second output bodies 46A, 46B rebound back to the outboard position to engage the corresponding receivers 30 of the storage compartment 14 and latch the door 18 in the closed position.

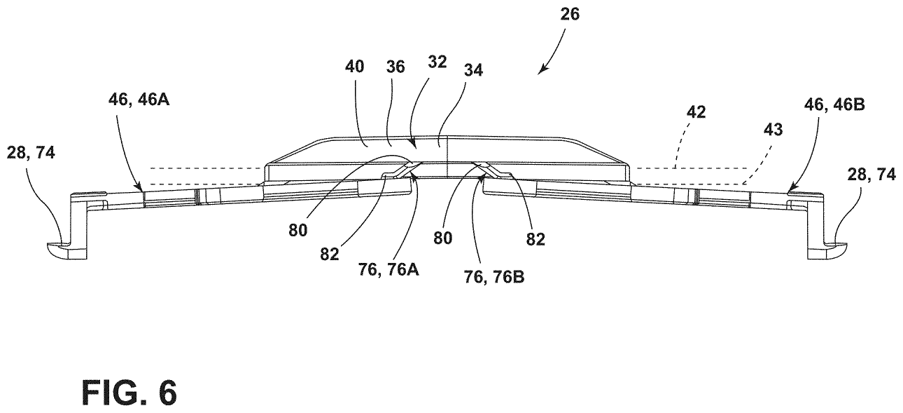

Referring now to FIGS. 5A-6, in some embodiments, the input body 32 can include an input body slide feature 76. In some embodiments, the input body 32 can include a plurality of input body slide features 76. For example, in the embodiment illustrated in FIGS. 5A-6, the input body 32 includes a first input body slide feature 76A and a second input body slide feature 76B. In various embodiments, the input body slide feature 76 extends from a proximal end 80 to a distal end 82, and the distal end 82 of the input body slide feature 76 is positioned outboard of the proximal end 80. For example, in the embodiment illustrated in FIGS. 5A and 5B, the first input body slide feature 76A extends from the proximal end 80 to the distal end 82 of the first input body slide feature 76A, which is positioned outboard of the proximal end 80. Further, the second input body slide feature 76B extends from the proximal end 80 to the distal end 82 of the second input body slide feature 76B, which is positioned outboard of the proximal end 80 of the second input body slide feature 76B. As illustrated, the proximal ends 80 of the first and second input body slide features 76A, 76B are nearer to each other than the distal ends 82 of the first and second input body slide features 76A, 76B are to each other.

In some embodiments, the proximal end 80 of the input body slide feature 76 is positioned proximate to the engagement surface 34 of the input body 32. As illustrated in FIGS. 5A and 5B, the proximal end 80 of the first input body slide feature 76A and the proximal end 80 of the second input body slide feature 76B are positioned proximate to the engagement surface 34 of the input body 32.

In various embodiments, at least a portion of the input body slide feature 76 slopes outboard and away from the engagement surface 34 toward the distal end 82 of the input body slide feature 76, such that the distal end 82 is outboard of the proximal end 80 and further than the proximal end 80 from the engagement surface 34. For example, as illustrated in FIGS. 5A and 5B, at least a portion of the first input body slide feature 76A slopes outboard and away from the engagement surface 34 toward the distal end 82 of the first input body slide feature 76A, such that the distal end 82 is outboard of the proximal end 80 of the first input body slide feature 76A and further than the proximal end 80 from the engagement surface 34. As further illustrated in FIGS. 5A and 5B, a portion of the second input body slide feature 76B slopes outboard and away from the engagement surface 34 toward the distal end 82 of the second input body slide feature 76B, such that the distal end 82 is outboard of the proximal end 80 of the second input body slide feature 76B and further than the proximal end 80 from the engagement surface 34.

Referring still to FIGS. 5A-6, in various embodiments, the output body 46 includes an output body slide feature 78. In some embodiments, the latch feature 24 can include a plurality of output body slide features 78. For example, in the embodiment illustrated in FIGS. 5A and 5B, the first output body 46A includes a first output body slide feature 78A, and the second output body 46B includes a second output body slide feature 78B. In the illustrated embodiment, each of the first and second output body slide features 78A, 78B includes a post 84 that extends outward from the first and second output bodies 46A, 46B, respectively, generally toward the input body pivot axis 42. It is contemplated that the output body slide feature 78 can include various features that are operable to slide along the corresponding input body slide feature 76 as described further herein.

In various implementations, the output body slide feature 78 is configured to contact the input body slide feature 76 and is operable to slide along the input body slide feature 76. For example, in the embodiment illustrated in FIGS. 5A and 5B, the first output body slide feature 78A contacts the first input body slide feature 76A and is operable to slide along the first input body slide feature 76A, and the second output body slide feature 78B contacts the second input body slide feature 76B and is operable to slide along the second input body slide feature 76B.

In various embodiments, contact between the input body slide feature 76 and the output body slide feature 78 prompts movement of the output body 46 from the outboard position to the inboard position as the input body 32 pivots from the first position to the second position. For example, in the embodiment illustrated in FIGS. 5A and 5B, contact between the first input body slide feature 76A and the first output body slide feature 78A prompts movement of the first output body 46A from the first outboard position (FIG. 5A) to the first inboard position (FIG. 5B) as the input body 32 pivots from the first position, as illustrated in FIG. 5A, to the second position, as illustrated in FIG. 5B. Further, contact between the second input body slide feature 76B and the second output body slide feature 78B prompts movement of the second output body 46B from the second outboard position (FIG. 5A) to the second inboard position (FIG. 5B) as the input body 32 pivots from the first position, as illustrated in FIG. 5A, to the second position, as illustrated in FIG. 5B.

In various embodiments, the output body slide feature 78 slides along the input body slide feature 76 as the output body 46 moves from the outboard position to the inboard position. In the embodiment illustrated in FIGS. 5A and 5B, the first output body slide feature 78A slides along the first input body slide feature 76A as the first output body 46A moves from the first outboard position to the first inboard position. Further, the second output body slide feature 78B slides along the second input body slide feature 76B as the second output body 46B moves from the second outboard position to the second inboard position. In various embodiments, the output body slide feature 78 slides along the input body slide feature 76 toward the proximal end 80 of the input body slide feature 76 as the output body 46 moves from the outboard position to the inboard position.

For example, as illustrated in FIGS. 5A and 5B, the first output body slide feature 78A slides along the first input body slide feature 76A toward the proximal end 80 of the first input body slide feature 76A as the first output body 46A moves from the outboard position, as illustrated in FIG. 5A, to the inboard position, as illustrated in FIG. 5B. Further, the second output body slide feature 78B slides along the second input body slide feature 76B toward the proximal end 80 of the second input body slide feature 76B as the second output body 46B moves from the second outboard position, as illustrated in FIG. 5A, to the second inboard position, as illustrated in FIG. 5B.

In some embodiments, the first and second output body slide features 78A, 78B move nearer to each other as the first and second output bodies 46A, 46B move from the first and second outboard positions (FIG. 5A) to the first and second inboard positions (FIG. 5B).

Referring now to FIG. 6, as shown in the illustrated embodiment, at least a portion of each of the first and second output bodies 46A, 46B is angled upward and inboard relative to a horizontal plane 43 that is parallel to the input body pivot axis 42. In some embodiments, the portion of the first and second output bodies 46A, 46B can be angled about 3° relative to the horizontal plane 43. Angling the output bodies 46, as illustrated, may enable the entire latch feature 24 to be printed as a single unitary body without undesirably fusing the first and second output bodies 46A, 46B with the input body 32 and/or the first and second input body slide features 76A, 76B. In various implementations, the first and second output bodies 46A, 46B are initially connected with the input body at formation by a bridge feature (not shown) that is removed before assembly of the latch feature 24 with the door latch assembly 26.

In operation of another exemplary embodiment of the door latch assembly 26, initially, the door 18 of the center console 16 within the vehicle interior 12 is in the closed position and the latch feature 24 coupled to the door 18 is in a latched position relative to the center console 16, such that the latch feature 24 prevents the door 18 from being moved from the closed position to the open position. In this configuration, the input body 32 of the latch feature 24 is in the first position, the first and second output bodies 46A, 46B of the latch feature 24 are in the outboard positions, such that the pawls 74 coupled to the first and second output bodies 46A, 46B are engaged with corresponding receivers 30 coupled to the storage compartment 14, and the first and second output body slide features 78A, 78B are in contact with the first and second input body slide features 76A, 76B, respectively. Next, the user pushes the engagement surface 34 coupled to the input body 32 of the latch feature 24, which causes the input body 32 to pivot from the first position to the second position about the input body pivot axis 42. As the input body 32 pivots from the first position to the second position, the contact between the first input body slide feature 76A and the first output body slide feature 78A prompts movement of the first output body 46A from the first outboard position to the first inboard position Likewise, the contact between the second input body slide feature 76B and the second output body slide feature 78B prompts movement of the second output body 46B from the second outboard position to the second inboard position as the input body 32 pivots from the first position to the second position. Movement of the first and second output bodies 46A, 46B to the inboard positions disengages the pawls 74 coupled to the first and second output bodies 46A, 46B from the corresponding receivers 30 of the storage compartment 14, such that the door 18 may be pivoted from the closed position to the open position.

The user stops pushing on the engagement surface 34 of the input body 32 as the door 18 is swung from the closed position to the open position. As the user releases the engagement surface 34, the first and second output bodies 46A, 46B move from the inboard positions to the outboard positions, the first and second output body slide features 78A, 78B slide outboard along the corresponding first and second input body slide features 76A, 76B, and the input body 32 moves from the second position back to the first position.

Next, the user moves the door 18 from the open position back to the closed position. As the door 18 enters the closed position, the pawls 74 coupled to the first and second output bodies 46A, 46B contact portions of the receiver 30 of the storage compartment 14 in such a way that the first and second output bodies 46A, 46B are moved toward the inboard positions as the door 18 moves toward the closed position. As the door 18 enters the closed position, the pawls 74 of the first and second output bodies 46A, 46B rebound back to the outboard position to engage the corresponding receivers 30 of the storage compartment 14 and latch the door 18 in the closed position.

The present disclosure may provide a variety of advantages. First, one or more or all of the portions of the latch feature 24 being integrally coupled as a single unitary body may reduce the number of parts necessary to construct an operable latch feature 24. Second, the connecting body 58 being coupled to the first and second output bodies 46A, 46B by the first and second connecting members 60A, 60B may aid in ensuring that the first and second output bodies 46A, 46B retract from the outboard positions to the inboard positions substantially equally to one another irrespective of what portion of the engagement surface 34 of the input device is pressed by the user. In practice, if a pressing force is exerted by the user on the left edge of the engagement surface 34 of the input body 32 (from the directional perspective of FIG. 3), the connecting member 60 will be pushed inwards towards the second connecting member position and pull the second output body 46B (i.e., the output body 46 on the opposite side) toward the inboard position of the input force. Thus, uneven retraction of first and second output bodies 46A, 46B due to off-center presses may be negated.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A door latch assembly, comprising:
a door operable between open and closed positions;
a housing coupled to the door; and
a latch feature coupled to the housing and operable, in the closed position of the door, between an engaged condition, wherein the latch feature is engaged with a receiver to retain the door in the closed position, and a disengaged condition, the latch feature comprising:
an input body having an input body slide feature and being operably coupled to at least one of the housing and the door and pivotable about an input body pivot axis between first and second positions, wherein movement of the input body between the first and second positions is constrained to pivotal movement by at least one of the housing and the door; and
an output body coupled to the input body by at least one pivot member and having an output body slide feature that is operable to slide along the input body slide feature, wherein the contact between the input body slide feature and the output body slide feature prompts movement of the output body from an outboard position to an inboard position as the input body pivots from the first position to the second position, wherein the output body slide feature slides along the input body slide feature as the output body moves from the outboard position to the inboard position, wherein the at least one pivot member is configured to pivot to allow the output body to move from the outboard position to the inboard position, and wherein movement of the output body from the outboard position to the inboard position causes the latch feature to enter the disengaged condition in the closed position of the door.

2. The door latch assembly of claim 1, wherein the input body slide feature extends from a proximal end to a distal end that is positioned outboard of the proximal end, and wherein the output body slide feature slides along the input body slide feature toward the proximal end of the input body slide feature as the output body moves from the outboard position to the inboard position.

3. The door latch assembly of claim 2, wherein the input body includes an engagement surface configured to be pushed by a user to move the input body from the first position to the second position.

4. The door latch assembly of claim 3, wherein the proximal end of the input body slide feature is positioned proximate to the engagement surface, and at least a portion of the input body slide feature slopes outboard and away from the engagement surface toward the distal end, such that the distal end is outboard of the proximal end and further than the proximal end from the engagement surface.

5. The door latch assembly of claim 4, wherein the output body slide feature comprises:
a post that extends outward from the output body generally toward the input body pivot axis.

6. The door latch assembly of claim 1, wherein movement of the output body from the outboard position to the inboard position is constrained to substantially linear movement by the housing.

7. The door latch assembly of claim 1, wherein the direction of the linear movement of the output body from the outboard position to the inboard position is substantially parallel to the input body pivot axis.

8. The door latch assembly of claim 1, wherein the input body is integrally coupled to the at least one pivot member and the at least one pivot member is integrally coupled to the output body.

9. The door latch assembly of claim 1, wherein at least a portion of the output body is angled upward and inboard in the closed position of the door and the outboard position of the output body.

10. The door latch assembly of claim 9, wherein the at least a portion of the output body is angled upward and inboard at an angle of about 3 degrees relative to a horizontal plane.

11. A latch feature, comprising:
an input body having a first input body slide feature and a second input body slide feature and being operable to pivot relative to at least one of a housing and a door about an input body pivot axis between first and second positions;
a first output body coupled to the input body by at least one first pivot member and having a first output body slide feature that is operable to slide along the first input body slide feature, wherein contact between the first input body slide feature and the first output body slide feature prompts movement of the first output body from a first outboard position to a first inboard position as the input body pivots from the first position to the second position, wherein the first output body slide feature slides along the first input body slide feature as the first output body moves from the first outboard position to the first inboard position, and wherein the at least one first pivot member is configured to pivot to allow the first output body to move from the first outboard position to the first inboard position as the input body pivots from the first position to the second position; and
a second output body coupled to the input body by at least one second pivot member and having a second output body slide feature that is operable to slide along the second input body slide feature, wherein contact between the second input body slide feature and the second output body slide feature prompts movement of the second output body from a second outboard position to a second inboard position as the input body pivots from the first position to the second position, wherein the second output body slide feature slides along the second input body slide feature as the second output body moves from the second outboard position to the second inboard position, and wherein the at least one second pivot member is configured to pivot to allow the second output body to move from the second outboard position to the second inboard position as the input body pivots from the first position to the second position.

12. The latch feature of claim 11, wherein the input body pivot axis is substantially parallel to the direction the first output body moves from the first outboard position to the first inboard position.

13. The latch feature of claim 11, wherein the first and second output body slide features move nearer to each other as the first and second output bodies move from the first and second outboard positions to the first and second inboard positions, respectively.

14. The latch feature of claim 11, wherein the first input body slide feature extends from a proximal end to a distal end that is positioned outboard of the proximal end, and wherein the first output body slide feature slides along the first input body slide feature toward the proximal end of the first input body slide feature as the first output body moves from the first outboard position to the first inboard position.

15. The latch feature of claim 14, wherein the input body includes an engagement surface configured to be pushed by a user to move the input body from the first position to the second position.

16. The latch feature of claim 15, wherein the proximal end of the first input body slide feature is positioned proximate to the engagement surface, and at least a portion of the first input body slide feature slopes outboard and away from the engagement surface toward the distal end, such that the distal end is outboard of the proximal end and further than the proximal end from the engagement surface.

17. The latch feature of claim 16, wherein the first output body slide feature comprises:
a post that extends outward from the first output body generally toward the input body pivot axis.

18. The latch feature of claim 11, wherein the at least one first pivot member is configured to bias the input body toward the first position and the first output body toward the first outboard position.

19. A latch feature for a door, comprising:
an input body operable to pivot between first and second positions relative to the door and having an input body slide feature; and
an output body coupled to the input body by a pivot member and having an output body slide feature that is operable to slide along the input body slide feature, wherein the contact between the input body slide feature and the output body slide feature causes the output body to move from an outboard position to an inboard position as the input body pivots from the first position to the second position.

20. The latch feature of claim 19, wherein the input body is integrally coupled to the pivot member and the pivot member is integrally coupled to the output body.
